(19) United States
(12) Patent Application Publication
(10) Pub. No.: US 2024/0354248 A1
(43) Pub. Date: Oct. 24, 2024

(54) DATA TRANSFER USING COHERENT DOORBELL UPDATES

(71) Applicants: Rahul Pal, Bangalore (IN); Ashish Gupta, San Jose, CA (US); Randy Bright, Sanford, NC (US); Yoanna Baumgartner, Austin, TX (US)

(72) Inventors: Rahul Pal, Bangalore (IN); Ashish Gupta, San Jose, CA (US); Randy Bright, Sanford, NC (US); Yoanna Baumgartner, Austin, TX (US)

(21) Appl. No.: 18/756,818

(22) Filed: Jun. 27, 2024

(51) Int. Cl. G06F 12/0804; G06F 13/16

(52) U.S. Cl. CPC G06F 12/0804; G06F 13/1668; G06F 2213/0026

(57) ABSTRACT

Systems or methods of the present disclosure may provide systems and techniques for efficiently transferring data between a host processing unit and connected devices using coherent doorbell register updates. For example, a method may include: receiving, via controller of host processing circuitry, an attempt to write data to a cacheable memory address from a processing unit of the host processing circuitry; transmitting, via the controller, an indication of the attempt to write to the cacheable memory address to a device; receiving, via the controller, an acknowledgment from the device that the cacheable memory address has been deallocated by the device; and writing, via the controller, the data to the cacheable memory address in response to the acknowledgement from the device.

### BACKGROUND

The present disclosure relates generally to data transfer between devices. More particularly, the present disclosure relates to maintaining cache coherence when transferring data between a host and a non-coherent device.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

A host processing unit may communicate with connected devices, such as peripheral devices, using interfaces such as Peripheral Component Interconnect Express (PCIe) and Compute Express Link (CXL). Data may be exchanged between the host processing unit and connected devices via Direct Memory Access (DMA) transfers. To initiate a DMA transfer, a host processing unit may write the data to be transferred and a descriptor in cacheable memory. The host processing unit may then send a doorbell via a memory-mapped input/output (MMIO) write to a memory-mapped register space of a connected device that triggers the connected device to read the descriptor and fetch the data. However, MMIO writes used for the doorbell may not be cacheable in the host processing unit, and may thus be slow and/or inefficient, especially for small data transfers, such as remote procedure calls (RPCs) used for microservices.

### BRIEF DESCRIPTION OF THE DRAWINGS

Various aspects of this disclosure may be better understood upon reading the following detailed description and upon reference to the drawings in which:

FIG. 1 is a block diagram of a system including a host processing unit that may perform data transfers with one or more devices using coherent doorbell updates, in accordance with an embodiment of the present disclosure;

FIG. 2 is a diagram of a process for arming a doorbell using coherent and non-coherent communication links, in accordance with an embodiment of the present disclosure;

FIG. 3 is a diagram of a process for monitoring doorbell addresses stored in the memory, in accordance with an embodiment of the present disclosure;

FIG. 4 is a flow chart of a method for arming a doorbell address that may be performed by a coherency controller of the host processing unit of FIG. 1, in accordance with an embodiment of the present disclosure;

FIG. 5 is a flow chart of a method for alerting a device of a write to a doorbell address that may be performed by the coherency controller of the host processing unit of FIG. 1, in accordance with an embodiment of the present disclosure;

FIG. 6 is a flow chart of a method for arming a doorbell address that may be performed by doorbell address monitor of the system of FIG. 1, in accordance with an embodiment of the present disclosure; and

FIG. 7 is a flow chart of a method for monitoring a doorbell address that may be performed by the doorbell address monitor of the system of FIG. 1, in accordance with an embodiment of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As mentioned, a host processing unit and connected peripheral devices may communicate via PCIe and/or CXL interfaces using Direct Memory Access (DMA) transfers. To initiate a DMA transfer, a host processing unit may write the data to be transferred and a descriptor in cacheable memory. The host processing unit may then send a doorbell via a memory-mapped input/output (MMIO) write to a memory-mapped register space of a connected device, and the connected device may read the descriptor and fetch the data. However, MMIO writes used for the doorbell may not be cacheable in the host processing unit, and may thus be slow and/or inefficient. Along with other considerations of a PCIe interface, a connected device may wait for updates to a “mailbox” register to begin work on a task (e.g., processing task, storage task), which may be computationally expensive. Further, it may be desirable to maintain coherency of doorbell registers and other caches, registers, and/or memory of the host processing unit among connected devices.

The present systems and techniques relate to embodiments for efficiently transferring data between a host processing unit and connected devices using coherent doorbell register updates. The host processing unit (e.g., host processing circuitry) may write doorbells in cacheable memory of the host processing unit and may use DMA to transfer data to a connected device using CXL.io and/or PCIe interfaces. Further, aspects of CXL, such as CXL.cache, may allow coherent doorbells by managing cache line ownership of doorbell addresses in cacheable memory. Functions, applications, and so on of a connected device can initialize (e.g., arm) a respective doorbell address by setting up one or more snoop-based monitors in a coherency controller of the host processing unit. Once a doorbell address is armed, a processing core of the host processing unit may attempt to write new data to the doorbell address while performing processing and/or data transfer functions. In response, the coherency controller may determine that the doorbell address is armed and may send an indication of the write attempt to a doorbell address monitor, also referred to herein as doorbell address monitoring circuitry, of a connected device corresponding to the armed doorbell address. The indication may include, for example, a CXL snoop sent on a CXL request line, and may be sent to the corresponding connected device on a response and/or request line used for data transfer between the host processing unit and the connected device. That is, host processing unit may utilize existing data transfer channels to send the indication to the connected device.

In response, the doorbell address monitor may send an indication, which may include an interrupt, status register change, or other message, to a device controller (e.g., device controller circuitry) of the connected device. It should be noted that, while other components, such as the coherency controller, may be capable of coherent communication (e.g., may communicate on coherent communication busses or links), the device controller may not be capable of coherent communication. As used herein, a “coherent” communications (e.g., indications, requests, responses, updates) may be sent on a coherent bus, link, or the like, and “non-coherent” communications may be transmitted on non-coherent busses and links. Additionally, the doorbell address monitor may identify an armed doorbell address for which the write is intended based on, for example, a data structure including currently armed doorbells of the device. The doorbell address monitor may then deallocate the identified doorbell address (e.g., in a locally-stored data structure) to reflect an ownership change for the doorbell address. After deallocation at the doorbell address monitor, the doorbell address monitor may send a response to the coherency controller on the CXL response line, and the response may indicate an acknowledgment by the doorbell address monitor that the identified doorbell address has been deallocated. After receiving the response, the coherency controller may proceed with a write of the data (e.g., from the original write received from the host processing unit) to the intended doorbell address.

In response to the indication received from the doorbell address monitor, the device controller may send a read to the memory, and the read may be intercepted by the coherency controller. The read may include an indication of the identified doorbell address. The coherency controller may then wait to receive a completion indication from the memory that the data of the write has been written to the intended doorbell address. In some embodiments, the coherency controller may store the read (e.g., in a local cache) until the completion indication is received from the memory. In response to receiving the completion indication, the coherency controller may forward the read to the memory. The memory may respond with data stored at the intended doorbell address, which may include the data of the write, and the coherency controller may forward the data to the device controller. In some cases, the coherency controller may forward the data to the device controller via the coherency controller and/or the doorbell address monitor. The device controller may then check the contents to determine whether the doorbell was updated.

It should be noted that components described herein, including the device controller, the doorbell address monitor, and the coherency controller, may be implemented in hardware, software, or both. For example, the doorbell address monitor may include circuitry of the connected device, firmware or software running on the connected device, or both. Likewise, the coherency controller may include circuitry of the host processing unit, such as a field-programmable gate array (FPGA) design of the host processing unit, software or firmware running on the host processing unit (e.g., executed by a processing core of the host processing unit), or both.

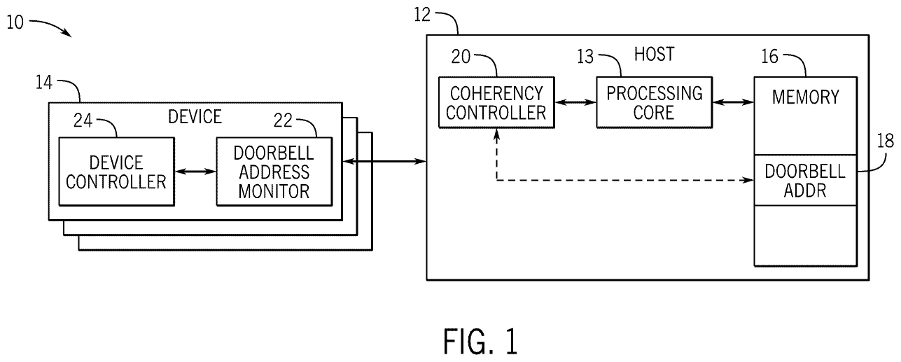

FIG. 1 is a block diagram of a system 10 including a host processing unit 12 that may perform data transfers with one or more devices 14 using coherent doorbell updates. As illustrated, the host processing unit 12 may include a processing core 13 that executes instructions stored in a memory of the host processing unit 12, such as a cacheable memory 16, which may include a cacheable memory in connection with the processing core 13. The cacheable memory 16 may include one or more doorbell addresses 18, and each of the one or more doorbell addresses 18 may include a cacheable memory address, also referred to herein as a cacheable doorbell address, that stores a doorbell for a device of the one or more devices 14. In some embodiments, multiple doorbell addresses 18 may correspond to a device 14. Further, in some embodiments, a doorbell address 18 corresponding to a device may store multiple doorbells for the device 14. The processing core 13 may, during operation of the system 10, attempt to write to a doorbell address of the one or more doorbell addresses 18 when, for example, the processing core 13 initiates a data transfer to a device 14.

The host processing unit 12 also includes a coherency controller 20 that monitors the one or more doorbell addresses 18 via, for example, DMA, interrupts, polling, or the like. Additionally, the coherency controller 20 may communicate with a doorbell address monitor 22 via a high-speed serial link, such as CXL and/or PCIe. The coherency controller 20 may also communicate with a device controller 24 of the device 14, which may be a non-coherent agent of the cacheable memory 16, directly or via the doorbell address monitor 22. For example, the coherency controller 20 may determine that the processing core 13 is attempting to write to a doorbell address of the one or more doorbell addresses 18 as part of a data transfer to a device 14, and may then send an indication of the write attempt to a corresponding doorbell address monitor 22 of the device 14 via a CXL response line. In response, the doorbell address monitor 22 may send an indication to the device control 24 via, for example, a communication bus of the device 14.

The device 14 and the host processing unit may use an existing CXL and/or PCIe data communication link, which may include request and response lines, to communicate information regarding the status of the one or more doorbell addresses 18. For example, a CXL link may include a request line used for transmitting requests between the device 14 and the host processing unit 12. The doorbell address monitor 22 may, based on instructions from the device controller 24, send a request (e.g., a RdOwnNoData request) to allocate a doorbell address for the device 14 on the request line of the CXL link (e.g., CXL.cache H2DReq line) to the processing core 13. In response, the processing core 13 may send a response (e.g., GO_E) on a response line of the CXL link (e.g., CXL.cache H2DResp). Similarly, once a doorbell is armed for a device 14, the coherency controller 20 may send indications of write attempts to the doorbell address monitor 22 on the request line of the CXL link, and may receive a response from the doorbell address monitor 22 on the response line of the CXL link.

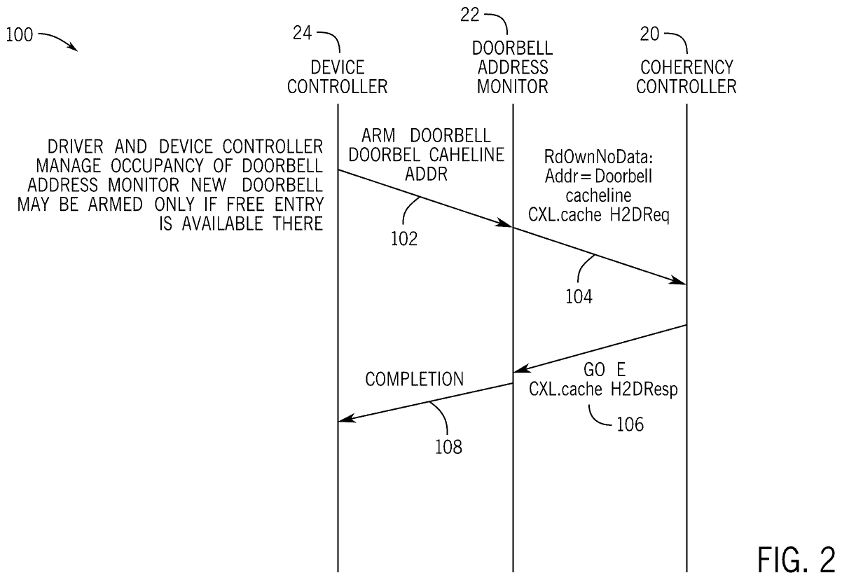

FIG. 2 illustrates a process 100 for arming a doorbell stored in a doorbell address (e.g., of the one or more doorbell addresses 18 of FIG. 1) for the device 14 using non-coherent communication links and coherent communication links. The process 100 may be initiated by the device controller 24 and performed by the doorbell address monitor 22 and the coherency controller 20 in the coherency domain. The device controller 24 may send an instruction 102, which may include a non-coherent instruction, to arm a doorbell for the device 14 to the doorbell address monitor 22, also referred to herein as setting up a snoop-based monitor of the doorbell. As illustrated, the instruction 102 may include an address (e.g., cache line) of a specific doorbell address. Based on the instruction 102, the doorbell address monitor 22 may send a request 104, on a coherent communication link, such as a CXL request line, to the coherency controller 20 to arm a doorbell address corresponding to the device 14.

In response, the coherency controller 20 may allocate a doorbell address for the device 14 (e.g., may give ownership of the doorbell address to the device 14). Allocation of the doorbell address may also include storing information related to which device the doorbell address is allocated for. If the doorbell address is successfully allocated, the coherency controller 20 may send a response 106 to the doorbell address monitor 22 using, for example, a CXL response line used to communicate with the device 14. If, however, the allocation is unsuccessful (e.g., the specified doorbell address is already allocated), the coherency controller 20 may send an indication of the failed allocation to the doorbell address monitor 22. In some embodiments, the response may include an indication of which doorbell address has been allocated for the device 14.

As mentioned, the device 14 may correspond to multiple doorbell addresses. As such, the doorbell address monitor may store a data structure of which doorbell addresses have been allocated to the device 14. Based on the response 106, the doorbell address may allocate the doorbell address within the data structure. Once the doorbell address is allocated by the doorbell address monitor 22, the doorbell address may monitor the allocated doorbell address by receiving indications of write attempts to the allocated doorbell address and by referencing the data structure including the allocated doorbell addresses. Additionally, based on the response 106, the doorbell address monitor may send an indication that allocation has been completed to the device controller 24.

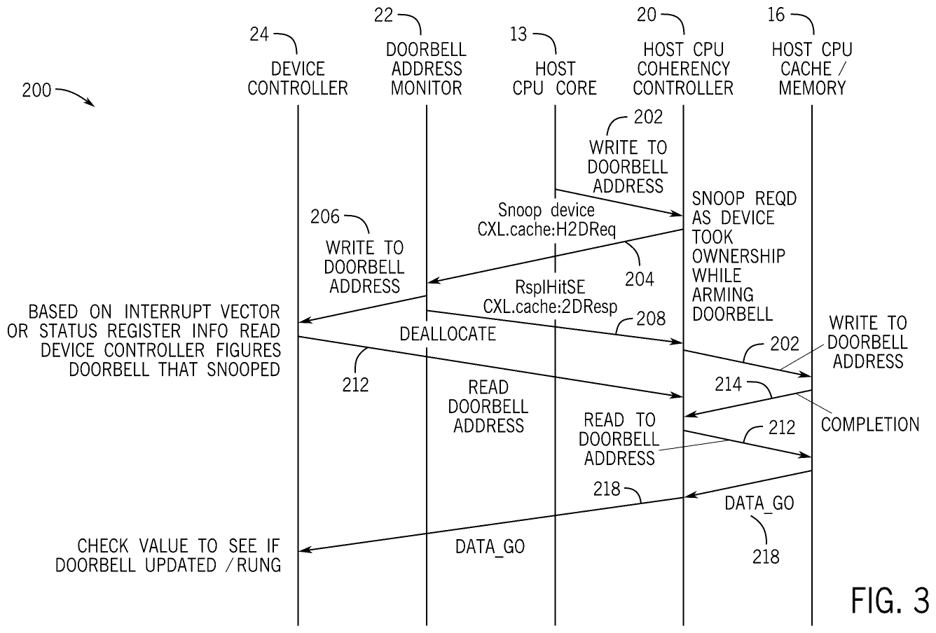

FIG. 3 is an illustration of a process 200 for monitoring doorbell addresses stored in the cacheable memory 16. The process 200 may be performed to notify a non-coherent agent, such as the device controller 24, of updates to a doorbell address. The process 200 may begin with the processing core 13 initiating a write 202 to a doorbell address of the cacheable memory 16. The coherency controller 20 may intercept and/or be alerted of the write 202 by, for example, one or more interrupts, polling the doorbell addresses, or monitoring communication lines between the processing core 13 and the cacheable memory 16. In some embodiments, the write 202 may indicate a doorbell address stored in the memory to which the processing core is attempting to write. In response to the write 202, the coherency controller 20 may determine if the intended doorbell address of the write 202 has been armed and allocated for a connected device. The coherency controller 20 may also determine a corresponding device for which the intended doorbell address is allocated.

If the intended doorbell address has been armed for a device, the coherency controller 20 may send an indication 204 of the write to the doorbell address monitor. As mentioned, the indication 204 may include a snoop and may be sent on a CXL request line linking the host processing unit 12 and the device 14.

In response, the doorbell address monitor 22 may send an indication 206 (e.g., an additional indication), which may include an interrupt as illustrated, status register change, or other suitable message, to the device controller 24. Additionally, the doorbell address monitor 22 may identify an armed doorbell address for which the write 202 is intended based on, for example, a data structure including currently armed doorbells of the device 14. The doorbell address monitor 22 may then deallocate the identified doorbell address (e.g., in a locally-stored data structure) to reflect an ownership change for the doorbell address. After deallocation at the doorbell address monitor 22, the doorbell address monitor 22 may send a response 208 to the coherency controller 20 on the CXL response line, and the response 208 may indicate an acknowledgment by the doorbell address monitor 22 that the identified doorbell address has been deallocated. After receiving the response 208, the coherency controller 20 may proceed with a write 202 of the data from the write 202 in the intended doorbell address.

In response to the indication 206 received from the doorbell address monitor 22, the device controller 24 may send a read 212 to the cacheable memory 16, and the read 212 may be intercepted by the coherency controller 20. The read 212 may include an indication of the identified doorbell address. The coherency controller 20 may then wait to receive a completion indication 214 (e.g., write acknowledgement) from the cacheable memory 16 that the data of the write 202 has been written to the intended doorbell address. In some embodiments, the coherency controller may store the read 212 (e.g., in a local cache) until the completion indication 214 is received from the cacheable memory 16. In response to receiving the completion indication 214, the coherency controller 20 may forward the read 212 to the cacheable memory 16. The cacheable memory 16 may respond with data stored at the intended doorbell address, which may include the data of the write 202. As illustrated, the coherency controller 20 may forward the data 218 to the device controller 24. In some cases, the coherency controller 20 may forward the data 218 to the device controller 24 via the coherency controller 20 and/or the doorbell address monitor 22.

The device controller 24 may read the data and take a corresponding action, such as performing a DMA copy of the data into memory of the device 14. Further, if the data indicates that the doorbell was not affected, the device 14 may rearm the doorbell (e.g., may request ownership of the doorbell again). If, however, the data indicates that the doorbell was affected, a command to deallocate and/or disarm the doorbell (e.g., to relinquish ownership) may be sent to the coherency controller 20.

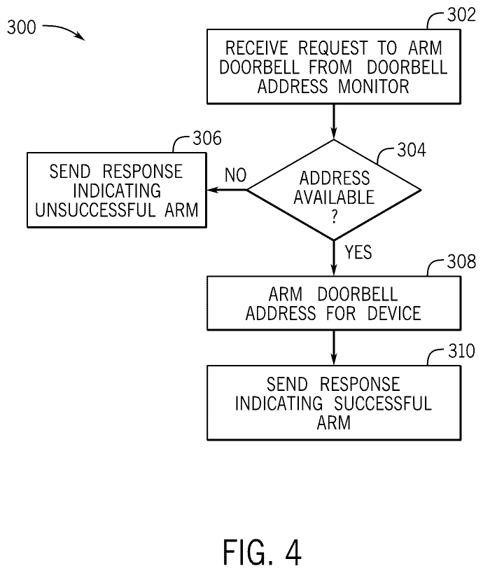

FIG. 4 is a flow chart of a method 300 for arming a doorbell address that may be performed by the coherency controller 20. The method 300 may be performed by the coherency controller 20 in the coherency domain. In block 302, the coherency controller 20 may receive a request from a doorbell address monitor (e.g., the doorbell address monitor 22) of a device (e.g., the device 14) to arm a doorbell address for the device. As mentioned, the request may be received via a CXL request line as a CXL read request and may specify a doorbell address. In block 304, the coherency controller 20 may determine if a doorbell address is available to be armed for the device. If a doorbell address is available, in block 306, the coherency controller 20 may arm the available doorbell address for the device. This may include moving ownership of the doorbell address from a host processing unit to the device by flagging the doorbell address as being owned by the device.

Additionally, in block 308, the coherency controller 20 may send a response indicating the successful arm to the doorbell address monitor from which the request was received. As mentioned, the response may be sent on a CXL response line. If, however, a doorbell address is unavailable or the arming is otherwise unsuccessful, the coherency controller 20 may send a response indicating an unsuccessful arm to the doorbell address monitor in block 306.

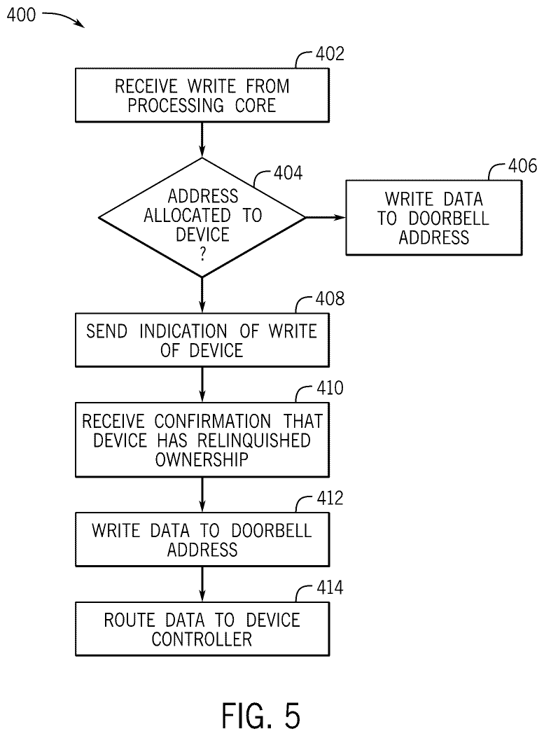

FIG. 5 is a flow chart of a method 400 for alerting a device of a write to a doorbell address that may be performed by the coherency controller 20. As with the method 300, the method 400 may be performed in the coherency domain. In block 402, the coherency controller 20 may receive (e.g. intercept) a write from a processing core (e.g., the processing core 13) to an intended doorbell address. The write may be sent by the processing core to initialize a data transfer to a device, for example, and may include data (e.g., a data packet). In response, the coherency controller 20 may determine, in block 404, whether the intended doorbell address of the write is allocated to a device. If the intended doorbell address is not allocated to a corresponding device (e.g., is owned by the processing core), in block 406, the coherency controller may complete the write or may allow the processing core to complete the write to the intended doorbell address.

If, however, the doorbell address is allocated to a corresponding device, in block 408, the coherency controller 20 may send an indication of the write to a doorbell address monitor of the corresponding device. As discussed herein, the indication may include a CXL snoop and may be sent on a CXL request line linking the host processing unit and the corresponding device. The coherency controller 20 may then receive a response 208 from the doorbell address monitor of the corresponding device on the CXL response line, and the response may indicate an acknowledgment by the doorbell address monitor that the intended doorbell address has been deallocated by the doorbell address monitor. In response, the coherency controller 20 may proceed with the write to the intended doorbell address and/or may allow the processing core to write to the intended doorbell address. In some embodiments, the coherency controller 20 may receive a read from the device controller. For example, the device controller may send a read request of the doorbell address to the coherency controller 20 in response to (e.g., at some point after) receiving an indication of a deallocation from the doorbell address monitor. In response, the coherency controller 20 may route the contents to the device controller after receiving confirmation that the write to the doorbell address was completed.

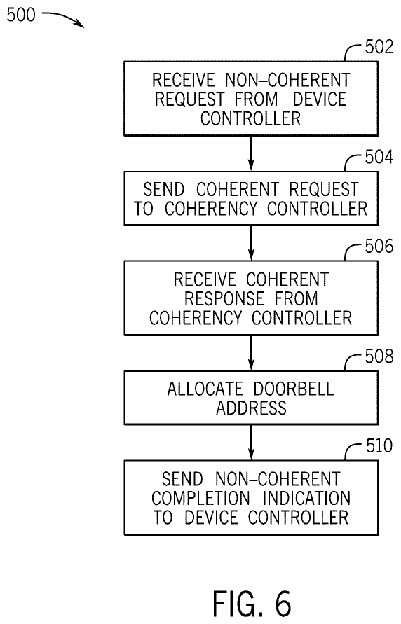

FIG. 6 is a flow chart of a method 500 for arming a doorbell address that may be performed by the doorbell address monitor 22. In block 502, the doorbell address monitor 22 may receive a non-coherent request from a device controller (e.g., the device controller 24) to arm a doorbell address. The non-coherent request may be initiated by the device controller to arm a doorbell address for an application or function of the device controller, for example. Based on the non-coherent request, the doorbell address monitor 22 may, in block 504, send a coherent request to a coherency controller of a host processing unit (e.g., the coherency controller 20 of the host processing unit 12). The coherent request may be sent on a coherent CXL request line to the coherency controller to arm a doorbell address corresponding to the device.

The doorbell address monitor 22 may then, in block 506, receive a coherent response from the coherency controller indicating whether the doorbell address initialization was successful. The coherent response may be received via, for example, a CXL response line used to communicate with a host processing unit. The doorbell address monitor 22 may then, in block 508, allocate the doorbell address in local memory and begin monitoring the doorbell address. In block 510, the doorbell address monitor 22 may send a non-coherent indication of completion of the arming process to the device controller (e.g., on a non-coherent bus of the device).

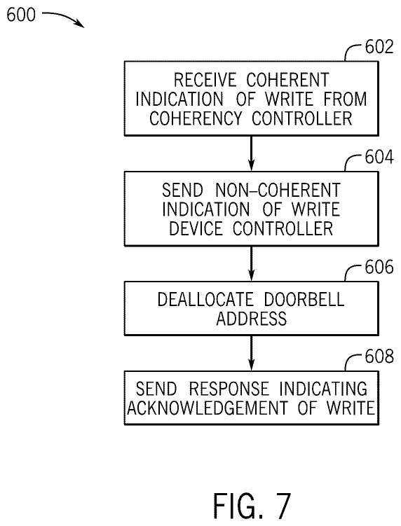

FIG. 7 is a flow chart of a method 600 for monitoring a doorbell address that may be performed by the doorbell address monitor 22. In block 602, the doorbell address monitor 22 may receive a coherent indication of a write to a doorbell address from the coherency controller. As mentioned, the indication may include a snoop and may be sent on a coherent CXL request line linking the host processing unit and the device. In response to the coherent indication, the doorbell address monitor 22 may send a non-coherent indication of the write to the device controller, such as an interrupt on a non-coherent bus of the device. The doorbell address monitor 22 may also deallocate the doorbell address from local memory of the device such that the doorbell address is, for example, no longer assigned to a function or application of the device. Finally, in block 608, the doorbell address monitor 22 may send a coherent response indicating an acknowledgement of the write and/or the deallocation performed in block 606.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112 (f).

### EXAMPLE EMBODIMENTS

EXAMPLE EMBODIMENT 1. A method, comprising: receiving, via controller of host processing circuitry, an attempt to write data to a cacheable memory address from a processing unit of the host processing circuitry; transmitting, via the controller, an indication of the attempt to write to the cacheable memory address to a device; receiving, via the controller, an acknowledgment from the device that the cacheable memory address has been deallocated by the device; and writing, via the controller, the data to the cacheable memory address in response to the acknowledgement from the device.

EXAMPLE EMBODIMENT 2. The method of example embodiment 1, wherein the indication of the attempt to write to the cacheable memory address is transmitted to a doorbell address monitor of the device on a coherent Compute Express Link (CXL), and wherein the doorbell address monitor is configured to transmit an indication of the attempt to write to the cacheable memory address to a device controller of the device on a non-coherent communication link.

EXAMPLE EMBODIMENT 3. The method of example embodiment 1, wherein the controller comprises electronic circuitry of the host processing circuitry.

EXAMPLE EMBODIMENT 4. The method of example embodiment 1, wherein the controller comprises machine-executed code stored in a machine readable medium of the host processing circuitry.

EXAMPLE EMBODIMENT 5. The method of example embodiment 1, wherein the indication of the attempt to write to the cacheable memory address is sent to the corresponding device in response to determining, via the controller, that the cacheable memory address comprises a doorbell address allocated to the corresponding device.

EXAMPLE EMBODIMENT 6. The method of example embodiment 1, comprising routing, via the controller, the data from the cacheable memory address to the device in response to the data being written to the cacheable memory address.

EXAMPLE EMBODIMENT 7. The method of example embodiment 1, comprising: receiving, via the controller, a read request of the cacheable memory address from device controller of the device; and routing, via the controller, the data from the cacheable memory address to the device controller in response to the read request and a write acknowledgement from a memory storing the cacheable memory address.

EXAMPLE EMBODIMENT 8. The method of example embodiment 7, wherein the device controller comprises a non-coherent agent.

EXAMPLE EMBODIMENT 9. The method of example embodiment 1, comprising: receiving, via the controller, a coherent request from doorbell address monitor of the device to arm a doorbell address for the device; and allocating, via the controller, the cacheable memory address for the device based on coherent the request to arm the doorbell address for the device.

EXAMPLE EMBODIMENT 10. The method of example embodiment 9, comprising: transmitting a coherent response to the doorbell address monitor, the coherent response indicating that the doorbell address has been allocated for the device, wherein the doorbell address monitor is configured to transmit an indication of completion of the allocation to device controller of the device.

EXAMPLE EMBODIMENT 11. The method of example embodiment 10, wherein the indication of completion is transmitted on a non-coherent bus of the device.

EXAMPLE EMBODIMENT 12. A system, comprising: a host processing unit comprising: processing circuitry; and coherency controller configured to: determine that the processing circuitry is attempting to write data to a cacheable doorbell address; transmit an indication of the write attempt to doorbell address monitor of a device corresponding to the cacheable doorbell address; allow the processing circuitry to write the data to the cacheable doorbell address in response to receiving an acknowledgement of the write attempt from the device; and the device, communicatively coupled to the host processing unit and comprising: the doorbell address monitor configured to: receive the indication of the write attempt; and transmit the acknowledgement of the write attempt to the coherency controller of the host processing unit.

EXAMPLE EMBODIMENT 13. The system of example embodiment 12, wherein the device is communicatively coupled to the host processing unit via a Compute Express Link (CXL).

EXAMPLE EMBODIMENT 14. The system of example embodiment 12, wherein the doorbell address monitor is configured to: deallocate one or more cacheable doorbell addresses associated with the device based on the indication of the write attempt.

EXAMPLE EMBODIMENT 15. The system of example embodiment 12, wherein the device comprises a device controller, and wherein the doorbell address monitor is configured to transmit an additional indication of the write attempt to the device controller on a non-coherent bus of the device.

EXAMPLE EMBODIMENT 16. The system of example embodiment 12, wherein the host processing unit comprises a memory, and wherein the cacheable doorbell address is located in the memory.

EXAMPLE EMBODIMENT 17. The system of example embodiment 16, wherein the memory comprises a cache.

EXAMPLE EMBODIMENT 18. A tangible, non-transitory, and computer-readable medium, storing instructions thereon, wherein the instructions, when executed, are to cause a processor to: receive a first request to arm a doorbell from a device controller via a non-coherent communication link; transmit a second request to arm the doorbell to coherency controller of a host processing unit via a coherent communication link; receive a first response indicating that the doorbell has been armed from the coherency controller via the coherent communication link; and transmit a second response indicating that the doorbell has been armed to the device controller via the non-coherent communication link.

EXAMPLE EMBODIMENT 19. The tangible, non-transitory, and computer-readable medium of example embodiment 18, wherein the coherent communication link comprises a Compute Express Link (CXL).

EXAMPLE EMBODIMENT 20. The tangible, non-transitory, and computer-readable medium of example embodiment 18, wherein the instructions cause the processor to deallocate the doorbell in local memory based on the first response.

What is claimed is:

1. A method, comprising:
receiving, via controller of host processing circuitry, an attempt to write data to a cacheable memory address from a processing unit of the host processing circuitry;
transmitting, via the controller, an indication of the attempt to write to the cacheable memory address to a device;
receiving, via the controller, an acknowledgment from the device that the cacheable memory address has been deallocated by the device; and
writing, via the controller, the data to the cacheable memory address in response to the acknowledgement from the device.

2. The method of claim 1, wherein the indication of the attempt to write to the cacheable memory address is transmitted to a doorbell address monitor of the device on a coherent Compute Express Link (CXL), and wherein the doorbell address monitor is configured to transmit an indication of the attempt to write to the cacheable memory address to a device controller of the device on a non-coherent communication link.

3. The method of claim 1, wherein the controller comprises electronic circuitry of the host processing circuitry.

4. The method of claim 1, wherein the controller comprises machine-executed code stored in a machine readable medium of the host processing circuitry.

5. The method of claim 1, wherein the indication of the attempt to write to the cacheable memory address is sent to the corresponding device in response to determining, via the controller, that the cacheable memory address comprises a doorbell address allocated to the corresponding device.

6. The method of claim 1, comprising routing, via the controller, the data from the cacheable memory address to the device in response to the data being written to the cacheable memory address.

7. The method of claim 1, comprising:
receiving, via the controller, a read request of the cacheable memory address from device controller of the device; and
routing, via the controller, the data from the cacheable memory address to the device controller in response to the read request and a write acknowledgement from a memory storing the cacheable memory address.

8. The method of claim 7, wherein the device controller comprises a non-coherent agent.

9. The method of claim 1, comprising:
receiving, via the controller, a coherent request from doorbell address monitor of the device to arm a doorbell address for the device; and
allocating, via the controller, the cacheable memory address for the device based on coherent the request to arm the doorbell address for the device.

10. The method of claim 9, comprising:
transmitting a coherent response to the doorbell address monitor, the coherent response indicating that the doorbell address has been allocated for the device, wherein the doorbell address monitor is configured to transmit an indication of completion of the allocation to device controller of the device.

11. The method of claim 10, wherein the indication of completion is transmitted on a non-coherent bus of the device.

12. A system, comprising:
a host processing unit comprising:
processing circuitry; and
coherency controller configured to:
determine that the processing circuitry is attempting to write data to a cacheable doorbell address;
transmit an indication of the write attempt to a doorbell address monitor of a device corresponding to the cacheable doorbell address;
allow the processing circuitry to write the data to the cacheable doorbell address in response to receiving an acknowledgement of the write attempt from the device; and
the device, communicatively coupled to the host processing unit and comprising:
the doorbell address monitor configured to:
receive the indication of the write attempt; and
transmit the acknowledgement of the write attempt to the coherency controller of the host processing unit.

13. The system of claim 12, wherein the device is communicatively coupled to the host processing unit via a Compute Express Link (CXL).

14. The system of claim 12, wherein the doorbell address monitor is configured to:
deallocate one or more cacheable doorbell addresses associated with the device based on the indication of the write attempt.

15. The system of claim 12, wherein the device comprises a device controller, and wherein the doorbell address monitor is configured to transmit an additional indication of the write attempt to the device controller on a non-coherent bus of the device.

16. The system of claim 12, wherein the host processing unit comprises a memory, and wherein the cacheable doorbell address is located in the memory.

17. The system of claim 16, wherein the memory comprises a cache.

18. A tangible, non-transitory, and computer-readable medium, storing instructions thereon, wherein the instructions, when executed, are to cause a processor to:
receive a first request to arm a doorbell from a device controller via a non-coherent communication link;
transmit a second request to arm the doorbell to coherency controller of a host processing unit via a coherent communication link;
receive a first response indicating that the doorbell has been armed from the coherency controller via the coherent communication link; and
transmit a second response indicating that the doorbell has been armed to the device controller via the non-coherent communication link.

19. The tangible, non-transitory, and computer-readable medium of claim 18, wherein the coherent communication link comprises a Compute Express Link (CXL).

20. The tangible, non-transitory, and computer-readable medium of claim 18, wherein the instructions cause the processor to deallocate the doorbell in local memory based on the first response.
